(19) United States
(12) Patent Application Publication
(10) Pub. No.: US 2015/0325055 A1
(43) Pub. Date: Nov. 12, 2015

(54) DISPLAY APPARATUS

(71) Applicants: Anil Kumar BALAKRISHNA, (US); Richard Paul WOOD, (US)

(72) Inventors: ANIL KUMAR BALAKRISHNA, BANGALORE (IN); RICHARD PAUL WOOD, BUCKINGHAMSHIRE (GB)

(21) Appl. No.: 14/653,003

(22) PCT Filed: Dec. 16, 2013
(86) PCT No.: PCT/IN2013/000774

§ 371 Date: Jun. 17, 2015

(30) Foreign Application Priority Data
Dec. 17, 2012 (IN) 5267/CHE/2012

(51) Int. Cl. G06T 19/20; H04N 13/04; H04N 7/15; H04N 7/14; H04N 5/359; G06T 19/00; G09G 3/36; G06T 13/40; G06T 15/02; G06T 15/50; H04N 13/00; G06T 7/00; G02B 27/22; G09G 3/34

(52) U.S. Cl. CPC G06T 19/20; G02B 27/2278; H04N 13/0443; H04N 13/0456; H04N 13/0495; H04N 7/15; H04N 7/147; H04N 5/3597; G09G 3/3406; G09G 3/36; G06T 13/40; G06T 15/02; G06T 15/506; H04N 13/0022; G06T 7/0065; G06T 19/00; G09G 2310/0237; G09G 2320/0233; G09G 2320/0633; G09G 2320/0666; G09G 2320/0693; G09G 2360/147; G06T 2200/04; G06T 2200/28; G06T 2207/10016; G06T 2207/10024; G06T 2207/10028; G06T 2207/20064; G06T 2207/20068; G06T 2207/20228

(57) ABSTRACT

The present invention relates to a compact display apparatus providing similarly sized but much brighter virtual 3D images to a viewer, the apparatus comprising an enclosure; LED illumination based electronic display device; partially transparent and partially reflective viewing surface; and contrast/interference filter screen. The enclosure houses the LED illumination based electronic display device, filter screen and the partially transparent and partially reflective viewing surface. The filter screen is positioned close to the surface of the LED illumination based electronic display device. The LED illumination based electronic display device projects a primary real image onto the filter screen and is optically transmitted onto the partially transparent and partially reflective viewing surface. The partially transparent and partially reflective viewing surface reflects a secondary virtual 3D image perceivable on the opposite side of the partially transparent and partially reflective viewing surface to the LED illumination based electronic display device.

### FIELD OF INVENTION

The present invention relates to a display apparatus. More specifically the present invention relates to a display apparatus that is relatively compact providing similarly sized but much brighter virtual 3D images to a viewer.

### BACKGROUND OF INVENTION

A display apparatus involving the combined effects of light transmission and reflection is commonly known as ‘Pepper's ghost’ which, traditionally, is an illusionary technique used in theatre, haunted house attractions, dark rides and in some magic tricks. Using plate glass and special lighting techniques, it can make objects seem to appear or disappear, to become transparent, or to make one object morph into another. The illusionary technique is also used to create virtual three-dimensional displays.

One of the problems in relation to, the known apparatus for creating virtual three-dimensional displays is that the enclosures required inherently involve apparatus occupying relatively large spaces. In addition, current display apparatus has a number of problems associated with them, for example, uneven tensioning of the foils, emission of milky light hue associated with systems based on front projection, distorted or elongated images occurring due to angled projection, etc. and most importantly they are difficult to observe in brightly lit environments.

Some existing prior arts are as follows:

U.S. Pat. No. 8,328,361 relates to projection apparatus comprising a projector, a frame and a screen which may be a foil. The apparatus is arranged to project an image of an object upon an inclined, partially reflective, screen such that a virtual image is created from light reflected from the screen, the virtual image appearing to be located behind the screen. This apparatus can only be effectively used in controlled and dark light conditions such as a theatre. In brighter environments the front projection screen suffers more from the “Milky hue” contrast problem.

U.S. Pat. No. 6,481,851 relates to a transparent-reflective display constructed to be alterable so that reflected images are viewed upon a transparent surface that can alter to a darkened surface, thereby changing contrast of the reflection. The display system is based on an LCD panel that acts as both a reflecting surface and also a contrast filter. The technology is limited in size and not available in single sheets of the size required. Such a method also requires accurate alignment of the viewer's eye with the enhanced contrast area of the screen and the virtual image resulting in reduced optimal viewing positions.

U.S. Pat. No. 8,149,509 discloses a polymeric projection screen having a retention member configured, in use, to be, in contact with at least one surface of the screen along at least a portion of at least one edge of said screen, characterized in that the retention member is bonded to the screen. The prior art relates to tensioning of the bi-axially oriented polymeric foil which is their description of a peppers ghost reflecting foil. This is a cumbersome and costly arrangement relying on proportionally a lot more space around the edges of the foil to create tension.

US20110157297 relates to a tele-presence system comprising a projector for generating an image, a projection screen for reviewing the image generated by the projector and generating a reflected image and a foil for reviewing the reflected image generated by the projection screen. The foil directs a partially reflected image toward an audience, the partially reflected image being perceived by the audience as a virtual image or hologram located on a viewing stage. Such arrangements and methodologies are cumbersome, costly and vulnerable to quality issues e.g. network errors, latency issues, inefficient bit rates etc.

Accordingly, there exists a need for an improved display type apparatus that is able to overcome the above disadvantages, requiring fewer components, is less demanding on space and significantly reduces costs. Advantageously, the present invention includes high brightness and high resolution LED screens technologies for generating the virtual 3D image. These technologies help to create a more compact structure and also are bright enough to be viewed in environments that are brighter than the existing projection technology can economically be delivered in.

### Objects of Invention

One or more of the problems of the conventional prior art may be overcome by various embodiments of the system and method of the present invention.

The primary object of the present invention is to provide a Pepper's Ghost display apparatus that is less demanding on space as compared with known apparatus providing similarly sized images to a viewer.

It is another object of the present invention to provide a much brighter virtual image than is currently achieved using projection based systems. The said brighter virtual image being more suited to brighter environments than is currently possible with existing technologies.

It is another object of the present invention to provide a relatively compact display apparatus that requires fewer components and provides significant cost savings over similar brightness projection based systems.

It is another object of the present invention, wherein the display apparatus providing virtual 3D images comprises of some combination of the following elements:—
An enclosure with one or more open viewing sides, with or without a rear or sides walls;
Light source to illuminate parts of the enclosure or objects placed inside the enclosure;
LED illumination based electronic display device or an LED backlit LCD panel,
wherein the LED illumination based electronic display device might commonly be referred to an LED Display;
Supplementary projected image devices and associated apparatus, such as first surface mirrors;
Display surface/contrast/or interference pattern filter screen; and
At least one partially transparent and partially reflective viewing surface

It is another object of the present invention, wherein the enclosure houses the LED illumination based electronic display device, the display surface and the partially transparent and partially reflective viewing surface.

It is another object of the present invention, wherein the partially transparent and partially reflective viewing surface is made of foil, plastic film, treated glass or plastics such as clear acrylic or any other suitable substrate with similar reflective properties.

It is another object of the present invention, wherein the display apparatus can be arranged to produce a virtual background set-works as a Pepper's ghost image.

In one aspect of the present invention a relatively compact display apparatus is provided, wherein the LED illumination based electronic display device or LED backlit LCD panel has a pre-determined pixel pitch, the said pre-determined pixel pitch is preferably 6 mm or less but not restricted to the said pitch sizes.

It is another object of the present invention, wherein the LED illumination based electronic display device or LED backlit LCD panel projects a primary real image onto the partially transparent and partially reflective viewing surface.

It is another object of the present invention, wherein the display surface/contrast/or interference pattern filter screen is arranged to display the primary real image and optically transmit the primary real image onto the partially transparent and partially reflective viewing surface.

It is another object of the present invention, wherein the partially transparent and partially reflective viewing surface is arranged to reflect a secondary virtual 3D image perceivable on the opposite side of the partially reflective screen and the LED illumination based electronic display device or LED backlit LCD panel.

It is another object of the present invention, wherein the use of the LED illumination based electronic display device or LED backlit LCD panel leads to less components and a significant cost saving.

It is another aspect of the present invention, wherein the LED illumination based electronic display or LED backlit LCD panel has high brightness and much improved black levels for reflecting a primary real image onto the partially transparent and partially reflective viewing surface arranged to display the primary real image and optically transmit the primary real image onto the transparent and partially reflective viewing surface. The partially transparent and partially reflective viewing surface reflects a secondary projected virtual 3D image perceivable on the opposite side of the partially transparent and partially reflective viewing surface thereby providing a much brighter display apparatus. The use of the high bright LED and LED back-lit LCD panels enables the use of less reflective but more transparent plastic films in the same lighting conditions as the more commonly used metalized plastic films or foils. The present invention also allows the use of the more traditional partially transparent and partially reflective viewing surfaces to be used in much brighter lighting conditions. The option to use a more highly transparent film than used in the prior art allows more impressive solutions to be used in conditions where less control of the lighting is afforded e.g. shopping malls.

It is another object of the present invention, wherein use of high contrast screens and contrast filters improves the illusions appearance thereby creating clear and sharp “Pepper's Ghost” type digital, virtual secondary images with an enhanced depth perception for the viewer of the secondary virtual 3D image.

In yet another aspect of the present invention, a display apparatus is provided for improving the performance of an image generated, by lower resolution LED's, wherein the brightness of the LED display is combined with the higher resolution of a projector which allows the use of lower resolution brighter LED's for most of the digital image but concentrated and therefore bright higher resolution projected sections of the image for important areas such as the digital representation of the face of a performer where the human eye lingers longer. This is a less expensive method for gaining the benefit of both high brightness and high resolution.

It is another object of the present invention, wherein the projector resolves the image on the contrast filter of the LED display, overlaps, and fills in detail.

In yet another aspect of the present invention, wherein the high resolutions LED display is arranged to display the primary real image where normally a virtual 3D image would appear.

It is another object of the present invention, wherein the virtual 3D image is produced using powerful colour variable lights or indeed projected images illuminating a fixed scenic structure. The fixed scenic structure is normally constructed in the horizontal plain, but by means of the reflective technology used replicating a structure that would normally be of a vertical construction.

In yet another aspect of the present invention, wherein the interference filter held in close proximity to the LED screen surface, prevents the appearance; on the surface of the partially transparent and partially reflective viewing surface; of an interference pattern generated by the multiple light sources of the LED screen.

It is another object of the present invention, wherein the arrangement increases the perception of depth without the physical requirement for depth.

It is another object of the present invention, wherein the arrangement significantly increases the brightness of the display allowing use outdoors and in areas where it is currently not a viable display technology.

In yet another aspect of the present invention, a display as described here can incorporate apparatus that is provided at a separate location for producing a live production of Peppers Ghost illusion/3D illusion in a second remote location, the apparatus comprising a high definition video camera, teleconferencing/video conferencing and telecasting equipment. By providing the apparatus at a separate location, the method comprising transmitting or broadcasting an image of a lit person or object which is filmed against a selected background in the separate location and generating by use of rapid image processing techniques an “alpha channel image” combined with online hosting of the virtual 3D image of the person or object in the separate location(s) thereby broadcasting the illusion of a tele-presence at the second location.

It is another object of the present invention, wherein use of available microphones, speakers and existing teleconferencing equipment compliments a variation of the display to allow the co-located person to interact with an audience at the second location. The teleconferencing equipment of the present invention differs from existing teleconferencing equipment in that it is a broadcasting solution and the person who becomes the telecast peppers ghost image will actually not see the alpha channel corrected images. Neither is there a need to film the participant through a semi reflecting plane. The teleconferencing equipment therefore differs from similar systems which focus on eye-to-eye teleconferencing solutions and that are regularly used in boardrooms and conference rooms. Moreover the prior art relies on CODEC's and methodologies which inherently have quality losses. By using wavelet based compression technology optimized for networks; realtime transmission of HDCP-compliant HDMI, DVI or RGB over IP networks is possible. Incorporation of such devices in the present invention leads to lossless, very high quality images with low latency which is capable of being transmitted at highly efficient bit rates. Typically this means that where prior art systems use say 20 mb of bandwidth 10 mb can suffice without any loss of quality. This has a huge cost benefit over the existing techniques of producing a realistic telecast of a person in a remote location. Advantageously the IT architecture used in the present invention also allows simultaneous recording and playback. This means that when a telecast is in several locations across several time zones an exact reproduction of the original telecast can be played back at a more appropriate time for the viewer without the need for the presenter to endure antisocial working hours to deliver the same experience to a different group of viewers at a different location.

It is another object of the present invention, wherein the apparatus further comprises of lighting system to generate shadows of the virtual 3D image as they might appear on stage if the virtual image was actually a real object. The lighting system is clustered together around and separated from each other by use of masks and separators. In this aspect of the present invention, there is advantageously a method for producing shadows on the stage that look realistic. When a real person or a real object stands on stage and is illuminated by stage lighting, the stage lighting cast shadows behind and around the person or object. This aspect of the present invention provides the Peppers Ghost virtual 3D image with what seems to be a more realistic presence in that shadows are created on the stage and the backdrop by the use of modified stage lighting. Therefore when the virtual 3D image appears and it would be reasonable that the viewer would have expected to see a shadow if the image were a real object, then the system of lighting is designed to generate the shadows that are expected by the viewer. This makes the virtual 3D image appear to cast a shadow in the same way as a real object would have done in similar lighting. The present invention relies on the use of masks and separation devices close to the stage lights. The stage lights are clustered together around and separated from each other using these masks and separators. In one manifestation, several lights are clustered together and are mounted on a motorized moving head similar to the standard stage lights. However the control of the movement of these lights is achieved through proprietary algorithms.

Another aspect of the present invention is directed to provide a method of providing virtual 3D images. This aspect focuses on the shaping of the real image to generate a virtual image plane that has a physical 3D shape to the image plane, thereby affording different viewing positions to experience slightly different viewing aspects and improving the perception of 3 dimensional depth to the virtual image.

In yet another aspect of the present invention, a plurality of displays without the rear stage wall as described here can be arranged to work together such that each display virtual image is carefully positioned to appear as if they are integrated to form the illusion of different viewing angles of any virtual image or object so arranged. Such arrangements might alternatively repeat the same image content on each side of the arrangement but the fact that the partially transparent and partially reflective viewing surfaces can be completely seen through when using materials described here and therefore unlike the prior art, the illusion of a real object appearing in the space behind the perimeter of the apparatus is much more compelling.

### SUMMARY OF INVENTION

Thus according to the basic aspect of the present invention, there is provided a compact display apparatus for providing virtual 3D images comprising:
An enclosure;
LED illumination based electronic display device;
Partially transparent and partially reflective viewing surface; and
Filter screen,
wherein the enclosure houses the LED illumination based electronic display device,
filter screen and the partially transparent and partially reflective viewing surface,
wherein the filter screen is positioned close to the surface of the LED illumination based electronic display device,
wherein the LED illumination based electronic display device projects a primary real image onto the filter screen,
wherein the primary real image is optically transmitted onto the partially transparent and partially reflective viewing surface, and wherein the partially transparent and partially reflective viewing surface reflects a secondary virtual 3D image perceivable on the opposite side of the partially transparent and partially reflective viewing surface to the LED illumination based electronic display device.

It is another aspect of the present invention, wherein the filter screen is a contrast filter screen.

It is another aspect of the present invention, wherein the filter screen is an interference filter screen.

It is another aspect of the present invention, wherein the primary real image is preferably an animated virtual 3D image.

It is another aspect of the present invention, wherein the LED illumination based electronic display device has a pre-determined pixel pitch for generating a virtual 3D image, the said pre-determined pixel pitch is preferably but not limited to 6 mm or less.

It is another aspect of the present invention, wherein the image generated by lower resolution LED's is enhanced by combining the brightness of the LED illumination based electronic display with higher resolution of one or more projectors.

It is another aspect of the present invention, wherein the projector resolves the image on the filter screen of the LED illumination based electronic display; the said image overlaps and fills in detail.

It is another aspect of the present invention, wherein lights are added to improve illusion, by illuminating any of the following: enclosure walls, enclosure structure, set-works, people or objects on view; or reflected so as to be on view.

It is another aspect of the present invention, wherein angle of inclination of the LED illumination based electronic display device with respect to the virtual 3D image plane is variable.

It is another aspect of the present invention, wherein the angle of inclination of the partially transparent and partially reflective viewing surface with respect to the LED illumination based electronic display device and the virtual 3D image plane is variable.

It is another aspect of the present invention, wherein the enclosure is in the form of a framework of struts.

It is another aspect of the present invention, wherein the apparatus is provided with one or more adjustable masking devices to vary the size of viewing aperture.

It is another aspect of the present invention, wherein the virtual 3D image appears as floating in mid space or over a real or imaginary a stage floor by providing a raised stage area positioned to the front and rear of the virtual 3D image plane.

It is another aspect of the present invention, wherein improved viewing of the virtual 3D image is achieved by increasing the blackness of the black areas of the LED illumination based electronic display device by using the contrast filter screen, the said blackness is improved by reducing the levels of light emanating from the supposedly black areas of the screen.

It is another aspect of the present invention, wherein the contrast filtering is performed at the real image surface.

It is another aspect of the present invention, wherein removal of an interference pattern on the partially transparent and partially reflective viewing surface is achieved by the incorporation of a diffusing interference filter screen.

It is another aspect of the present invention, wherein the interference filtering is performed at the real image surface.

It is further aspect of the present invention, wherein the apparatus further comprises of high definition video camera, teleconferencing and telecasting equipment provided at a separate location for producing an animated production of 3D illusion in a second remote location, the said apparatus being based on lossless discrete wavelet transform—DWT, CODEC technology.

It is yet another aspect of the present invention, wherein the apparatus further comprises of lighting system to generate faux shadows of the virtual 3D image.

It is another aspect of the present invention, wherein the lighting system is clustered together around and separated from each other by use of masks and separators.

It is another aspect of the present invention, wherein the lighting system is clustered together and is mounted on a motorized moving head.

It is another aspect of the present invention, wherein pluralities of displays without some or all of the rear enclosure walls or sides; are integrated together to allow the viewer a clear line of sight through the apparatus to the other side and the said virtual images thereby appearing to float in the middle of a volume defined by the edges of the plurality of displays.

Another aspect of the present invention is directed to provide a compact display apparatus for providing virtual 3D images comprising:
An enclosure;
LED illumination based electronic display device;
Partially transparent and partially reflective viewing surface; and
Light source or illuminated background volume,
wherein the enclosure houses the LED illumination based electronic display device,
and the partially transparent and partially reflective viewing surface,
wherein the LED illumination based electronic display device provides the primary real image and is optically transmitted onto the partially transparent and partially reflective viewing surface, and
wherein the partially transparent and partially reflective viewing surface reflects a secondary virtual 3D image perceivable on the opposite side of the partially transparent and partially reflective viewing surface to the LED illumination based electronic display device.

It is another aspect of the present invention, wherein the primary real image is preferably an animated virtual 3D image.

It is another aspect of the present invention, wherein the LED illumination based electronic display device has a pre-determined pixel pitch for generating virtual 3D image, the said pre-determined pixel pitch is preferably 6 mm or less.

It is another aspect of the present invention, wherein the image generated by lower resolution LED's is enhanced by combining the brightness of the LED illumination based electronic display with higher resolution of one or more projectors.

It is another aspect of the present invention, wherein lights are added to improve illusion, by illuminating any of the following: enclosure walls, enclosure structure, set-works, people or objects on view; or reflected so as to be on view.

It is another aspect of the present invention, wherein angle, of inclination of the LED illumination based electronic display device with respect to the virtual 3D image plane is variable.

It is another aspect of the present invention, wherein the angle of inclination of the partially transparent and partially reflective viewing surface with respect to the LED illumination based electronic display device and the virtual 3D image plane is variable.

It is another, aspect of the present invention, wherein the enclosure is in the form of a framework of struts.

It is another aspect of the present invention, wherein the apparatus is provided with one or more adjustable masking devices to vary the size of viewing aperture.

It is another aspect of the present invention, wherein the virtual 3D image appears as if floating in mid space upon or over a real or imaginary stage floor by providing a raised stage area positioned to the front and rear of the virtual 3D image plane.

It is another aspect of the present invention, wherein the apparatus further comprises of high definition video camera, teleconferencing and telecasting equipment provided at a separate location for producing an animated production of 3D illusion in a second remote location, the said apparatus being based on lossless discrete wavelet transform—DWT, CODEC technology.

It is another, aspect of the present invention, wherein the apparatus further comprises of a lighting system to generate faux shadows of the virtual 3D image.

It is another aspect of the present invention, wherein the lighting system is clustered together around and separated from each other by use of masks and separators.

It is another aspect of the present invention, wherein the lighting system is clustered together and is mounted on a motorized moving head.

It is another aspect of the present invention, wherein pluralities of displays without some or all of the rear enclosure walls or sides; are integrated together to allow the viewer a clear line of sight through the apparatus to the other side and the said virtual images thereby appearing to float in the middle of a volume defined by the edges of the plurality of displays.

Another aspect of the present invention is directed to a method of providing virtual 3D image comprising:
producing a primary real image onto display surface that is irregular;
transmitting the primary real image onto a partially transparent and partially reflective viewing surface;
reflecting a visible secondary image perceivable on the opposite side of the partially transparent and partially reflective viewing surface to the irregular display surface; and electronically processing either projectors or LED illumination based electronic display device to create an undistorted secondary image,
wherein the secondary image created is a digital, virtual 3D image, and
wherein the irregular display surface is the rear projection screen or contrast filter or interference filter screen moulded to a desired shape to achieve the desired three-dimensional effect in the reflected virtual secondary image to provide, viewer with a different viewing aspects of an object.

Yet another aspect of the present invention is directed to a method for producing an animated production of 3D illusion in a second remote location by providing the apparatus at a separate location, the method comprising:
transmitting or broadcasting an image of a lit person or object which is filmed against a selected background in the separate location; and
generating by use of rapid image processing techniques to generate an alpha channel image combined with online hosting of the virtual 3D image of the person or object in the separate location(s) thereby broadcasting a tele-presence at the second location.

Yet another aspect of the present invention is directed to a method of providing secondary image, comprising:
mounting partially transparent and partially reflective viewing surface within a housing enclosure; and
tensioning the partially transparent and partially reflective viewing surface by one or more tensioning methods,
wherein the partially transparent and partially reflective viewing surface includes at corner edge regions eyelets which pierce the partially transparent and partially reflective viewing surface;
wherein the eyeleted partially transparent and partially reflective viewing surface is tensioned by the tensioning device with a tensioning force being applied in a diagonal configuration and emanating from a centre zone of the partially reflective screen,
wherein the partially transparent and partially reflective viewing surface reflects a secondary virtual 3D image plane perceivable on the opposite side of the partially transparent and partially reflective viewing surface, and
wherein the secondary virtual 3D image appears in a plane transverse to a viewing axis of display apparatus, and transverse to the screen upon which the primary real image is displayed.

It is another aspect of the present invention, wherein the diagonal tensioning force is achieved by the use of nylon fishing wire and cable ties.

It is another aspect of the present invention, wherein the diagonal tensioning force is achieved by the use of nylon fishing wire and cable ties.

It is another aspect of the present invention, wherein the diagonal tensioning force is complemented with force pulled in other directions.

It is another aspect of the present invention, wherein the complimentary tensioning force is applied to a flexible partially transparent and partially reflective viewing surface and is complemented with forces pulled in other directions.

It is another aspect of the present invention, wherein the force in other directions is applied by folding an edge over a piece of box framework and by means of eyelets in the flexible partially transparent and partially reflective, viewing surface and bungee cord threaded through said eyelets and attached to the box framework, tension is maintained.

It is another aspect of the present invention, wherein the force in other directions is applied by the use of nylon fishing wire and cable ties and holes either eyeleted or otherwise prepared in the edges of the partially transparent and partially reflective viewing surface.

### BRIEF DESCRIPTION OF THE DRAWINGS

FIG. 1: illustrates an enclosure with LED display positioned on ceiling of housing enclosure.

FIG. 2: illustrates an enclosure with LED display positioned on floor of housing enclosure.

FIG. 3: illustrates an enclosure with LED display and illuminated fixed set-works and the top of the reflecting surface leaning towards the front and the bottom set back from a vertical position under the top/ceiling.

FIG. 4: illustrates an enclosure with LED display and illuminated fixed set-works positioned on the ceiling of the housing enclosure.

FIG. 5: illustrates an enclosure with primary image being generated in a non-linear non-flat contoured surface showing one example of how this contouring can be arranged.

FIG. 6: illustrates an enclosure with primary image being generated in a non-linear none flat contoured surface showing a different example of how this contouring can be arranged.

FIG. 7: illustrates corner arrangement of thermally or chemically welded or fused corners and eyelets.

FIG. 8: illustrates an arrangement, with the LED display positioned on the floor, and a higher resolution projector to improve the performance of an image that is generated by the lower resolution LEDs.

FIG. 9: illustrates an arrangement, with the LED display positioned vertically under the top/ceiling, and a higher resolution projector to improve the performance of an image that is generated by the lower resolution LEDs. This figure also shows how the interference filter (6) is positioned relative to the LED screen.

### DETAILED DESCRIPTION OF THE INVENTION WITH REFERENCE TO THE ACCOMPANYING FIGURES

The present invention as herein described relates to a display apparatus that is relatively compact providing similarly sized but much brighter virtual 3D images to a viewer. The display apparatus can be arranged to produce a virtual background set-works as a Pepper's ghost/virtual 3D image.

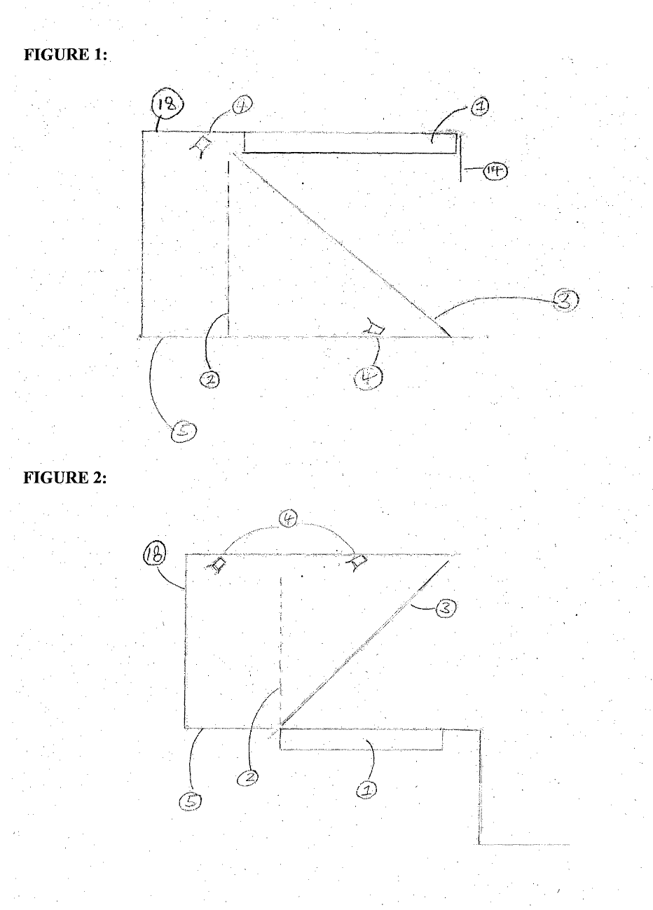

Referring to FIG. 1, the display apparatus comprising of an enclosure (18) which houses LED illumination based electronic display device or an LED backlit LCD panel (1); and partially transparent and partially reflective viewing surface (3). The enclosure housing is preferably constructed from black non-reflective material and sometimes lined with curtains. The reflective screen/surface is a partially reflective screen, which is made of foil, plastic film, treated glass or plastics such as acrylic or any other suitable substrate with similar reflective and transparent properties. The LED illumination based electronic display device might commonly be referred to an LED display device. The LED display device (1) is in the form of high brightness and relatively high resolution LED display technologies having a pixel pitch of substantially 6 mm or less for generating virtual 3D image. The LED display technologies help to create a more compact structure and also are bright enough to be viewed in environments that are brighter than the existing projection technology. The LED display device (1) has high brightness over 1500 nit and often 5000 nit or more and much improved system black levels i.e., when the unit is supposed to be displaying black in certain areas of the image it does not substantially also leak unwanted light through areas that are supposed to be black.

The primary real image displayed on the screen is optically transmitted to the partially transparent and partially reflective viewing surface (3) arranged at an appropriate angle to the LED display device (1) and held taught within the enclosure (18). The viewer looking through a viewing aperture in the enclosure looks through the partially transparent and partially reflective viewing surface (3), which is translucent and reflects a secondary image representative of the primary real image in a position perceivable by the viewer as a virtual 3D image. The reflected virtual 3D image plane (2) (shown for diagrammatic reasons as a dotted line) is on the opposite side of the partially reflective screen (3) to the LED display device (1) and is substantially perpendicular to the viewing axis. The angles between the LED display device (1), the virtual reflected 3D image plane (2) and the partially reflecting screen (3) are set by the position of the display device (1) relative to the partially transparent and partially reflective viewing surface (3); such that, the angle between these two items is always the same as the angle between the virtual reflected 3D image plane (2) and the partially transparent and partially reflective viewing surface (3). Normally, the angle of inclination of the LED display device (1) with respect to the virtual 3D image plane (2) and the angle of inclination of the partially transparent and partially reflective viewing surface (3) with respect to the LED display device (1) and the virtual 3D image plane (2) is variable but fixed such that the virtual image plane is vertically orientated. Particularly, the angle between the primary display device (1) and the virtual reflected 3D image plane (2) is 90 degrees and the position of the partially transparent and partially reflective viewing surface 3) is 45 degrees from each of the other two when viewed in a side elevation drawing such as FIG. 1.

When the LED display device (1) is set to be horizontal, this arrangement results in a desirable vertical virtual image plane. However, there are circumstances when an angle other than 45 degrees could be beneficial to the set-up of the illusion and thereby provide a design advantage. For this reason these other setup angles are also included as advantageous. For instance, a vertical virtual image with the real image at 60 degree to the virtual image plane can be created by bisecting the angle between virtual and real image. Importantly, it is normal that the virtual 3D image (2) will be vertical; and therefore different angles will normally, but not exclusively, be based relative to a vertical virtual, image plane (2).

Lights (4) are used to illuminate other set works and people that interact with and compliment the virtual reflected image (2). This improves the perception of 3D and also by overwriting the effect of reflected system black errors in any primary display makes the reflected virtual image frame appear more see-through in the black areas of the virtual reflected 3D image (2). The lights being variable in colour, temperature, hue and brightness intensity. When this additional light reflects off any of the following:—enclosure walls, enclosure structure, set-works, people or objects; and passes through the partially transparent and partially reflective surface to the viewer its intensity and colour when compared to the colour and brightness intensity of the reflected light from the primary real image surface will determine how ghostlike or solid the reflected image appears to be. When the reflected real image brightness intensity is very much greater than that of the illumination of the: enclosure walls, enclosure structure, set-works, people or objects; then the virtual image will appear solid. Where the real image has black or near black content the viewer will see through the respective areas of the reflected virtual image plane and see more intensely illuminated areas, people or objects.

The enclosure housing is of a relative compact nature owing to the fact that the LED primary display is more compact than other projection technologies. The enclosure (18) is in the form of a framework of struts to be covered with a suitable material. Around the region of the viewing aperture, there may be one or more adjustable masking devices (14), which can vary the size of the aperture. In some arrangements the sides and or walls of the enclosure are deliberately left out. In such arrangements it is preferable to hang a black curtain on a far wall of the building if inside and directly behind the virtual image from the point of view of all the intended observers.

FIG. 2 illustrates the enclosure (18) with LED display device (1) positioned on the floor of enclosure and the top of the partially transparent and partially reflective viewing surface (3) leaning forward towards the front; and the bottom set back from a vertical position under the top edge. The difference between the version shown in FIG. 2 and, that of FIG. 1 is that the primary display surface is, in this embodiment, the interference or contrast filter (6) backlit by the LED. This surface is hidden from view of the audience by virtue of its position on the floor of a raised version of the stage area (5). The raised stage area (5) is positioned to the front and rear of the virtual image plane and by virtue of its depth; improves the appearance of the virtual 3D image plane by facilitating floating in mid space. The performers will stand at the stage area to interact with the virtual 3D images. The other apparatus is inverted from its positions in FIG. 1 in a similar relationship; The change of orientation described in FIG. 2 relative to FIG. 1 could also be similarly rearranged to accommodate an arrangement laid on its side. In which case obscuring the view of the primary image again requires careful positioning of the audience and masking devices to hide the real image from the viewer's line of sight.

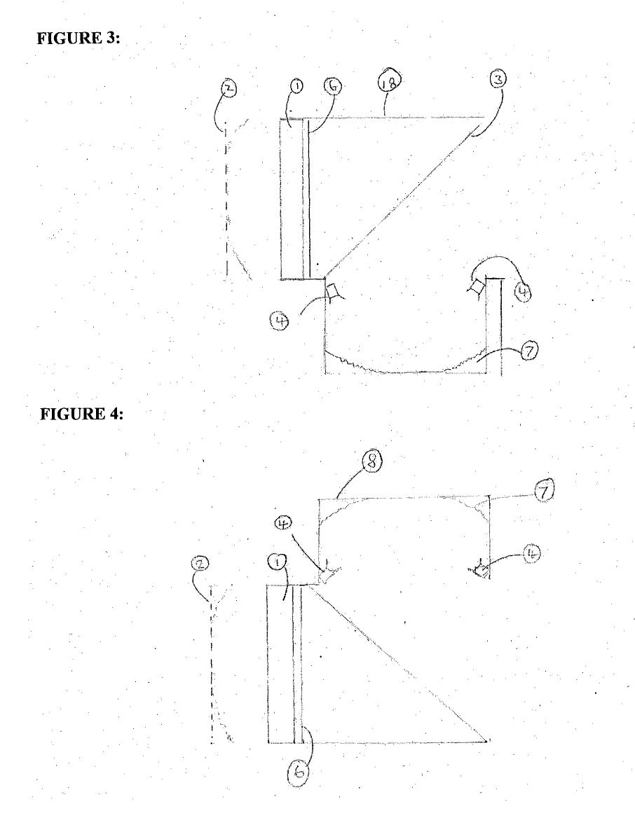

FIG. 3 illustrates the enclosure (18) with the LED display device (1) positioned so that the primary image is viewed directly but the virtual 3D image (2) being generated by a horizontally orientated and illuminated fixed set-works (7) and the top of the partially transparent and partially reflective viewing surface (3) leaning towards the front and the bottom set back from a vertical position under the top edge of this same plane. The primary LED display device (1) is positioned so that the viewer will get the full benefit of the screens brightness. The fixed background set-works (7) are positioned on the floor of the enclosure. The contrast filter (6) is positioned close to the surface of the LED display device (1). The unit's full brightness can be viewed directly and without the reduction in power that occurs when you reflect the primary image on the partially transparent and partially reflective viewing surface (3). This arrangement can be viewed in much brighter lighting conditions than with other Pepper's Ghost display technologies. This is important because the human eye will shutter down in high bright conditions and will not see displays designed with lower brightness outputs. The contrast filter (6) works to improve/increase the black in the areas of the primary screen which are intended to be black and therefore improves the ability of the viewer to see the virtual reflected image plane (2) at the position that it is located on the diagram. The contrast filtering is performed at the real image surface and not at the reflecting surface.

The 3D illusion is maintained by the use of a fixed background set-works (7) orientated in the floor such that when lit with a plurality of very strong lights (4) creates the impression of a vertical background at the reflected virtual 3D image plane (2). The fixed background set-works (7) can also have other LED lights embedded into its structure, which can be arranged, for example, to develop a vanishing point effect as often used by artists who wish to create the impression of depth on a flat canvas. Similarly, other areas are projected onto using high-bright projectors and “go-bo” light projectors in similar positions to the lights (4); giving the impression of different depths and textures to the virtual reflected 3D image plane (2). The position of the reflected virtual 3D image plane (2) will normally; but not exclusively; be behind the rear wall of the housing enclosure. This makes for a very compact unit from front to back and allows these systems to be more easily fitted to vehicles and other stages with limited depths.

Advantageously the LED display device can positioned on a moving mechanism to allow the content that is viewed directly to pass through the reflected virtual set works image plane, this allows some special effects to be produced in a way, which is not possible with other arrangements or technologies.

FIG. 4 illustrates the enclosure (18) with LED display device positioned so that the primary real image is viewed directly but the virtual 3D image (2) being generated by for example a horizontally orientated and illuminated fixed set-works (7) which are positioned on the ceiling (8) of the enclosure. Other angles of orientation can also be set up in a similar manner as described elsewhere for the relationship of the virtual image plane (2) the primary display (1) and the partially transparent and partially reflective viewing surface. The lights (4) are used in a similar manner to the way they are in FIG. 3 particularly but not exclusively, when the ceiling is opaque. In certain instances the ceiling (8) being a differentially transparent surface is capable of being back illuminated by the sunlight. As with FIG. 3, the primary LED display (1) of FIG. 4 is positioned in such a way that the viewer will get the full benefit of the screens brightness. When required the contrast filter (6) is positioned close to the surface of the LED screen (1). Some screens can work without this measure but there are several benefits of incorporating it into the design including cost. However, the fixed background set-works (7) are positioned on the ceiling of the housing enclosure and the brightness of the illumination on the fixed background set-works (7) is complimented by the use of semi-transparent surfaces embossed with variable transparency surfaces. The semi-transparent versions of the fixed background set-works (7) allow sunshine to boost the strength of the light that is seen in the virtual reflected 3D image (2).

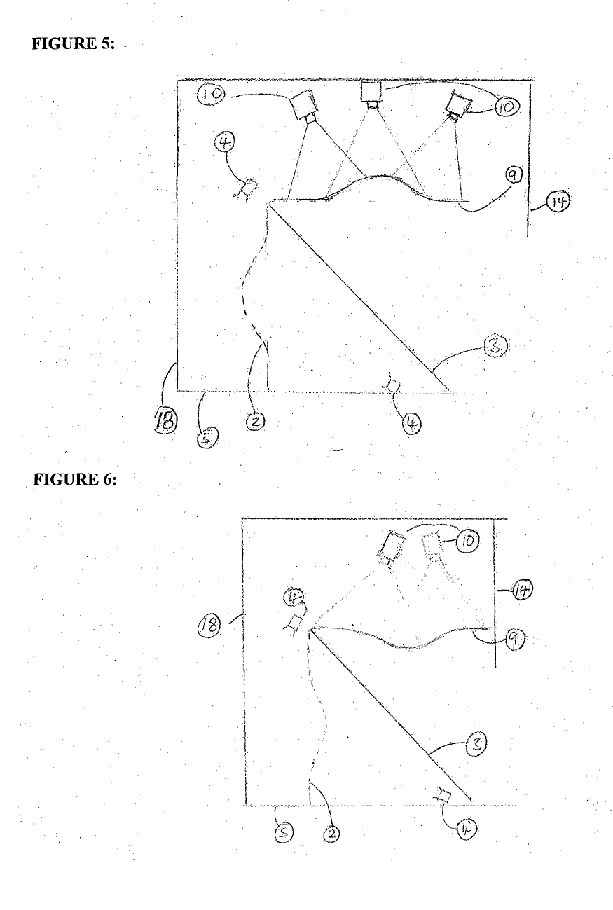

FIG. 5 illustrates the enclosure (18) with the primary image being generated in or on a non-linear non-flat contoured surface and shows one example of how this contouring can be arranged. The display apparatus shows a rear projection screen (9) as the primary display image, but the important feature of it is an irregular or uneven rear display surface/projection screen (9) in the sense that it is not planar. In this version, the rear, display surface/projection screen (9) is for example but not exclusively, made from a pigmented thermo-formed plastics material, but other methods of creating an uneven display surface are readily available. Although shown being illuminated from the rear by the projector(s) (10), this surface may also be the contrast filter and may be illuminated from the rear by a flexible LED display in a similar manner to that shown in FIG. 1. Alternatively front projection is another possible method for creating the primary real image. In the embodiment shown in FIG. 5, the primary real image is projected by the projector(s) (10) onto the irregular display surface/screen (9) and is electronically processed and manipulated by projection mapping hardware and other electronic image correction techniques to create an image, preferably animated virtual 3D image, on the irregular display surface/screen (9). The secondary image reflected in this manner from the partially reflective screen/surface (3) results is a digital, virtual Pepper's Ghost image having a relatively high quality of three-dimensional form owing to the increased depth perception by the viewer than when compared with projecting the primary real image onto a planar flat display surface. Moreover, unlike the case with flat display surfaces, the viewer will be able to see a slightly different reflected secondary image from different viewing angles, which is more consistent with the viewing of a real object. This will apply even if, for example, the viewer observes the same frame of a paused video from different viewing positions. The electronic processing and manipulation of the image is necessary in order to avoid the viewed virtual image being distorted owing to the shape of the irregular display surface/screen (9).

In this way, it is possible to change the viewer's perspective of an object. For example, if it is desired to show the destruction of a complete building into ruins, the irregular display surface/screen (9) can be formed into the necessary shape to form a three-dimensional virtual image of the building. Conventionally, this type of animation required two physical models, one on either side of the partially reflective screen (3) with changing illumination from one model to the other.

FIG. 6 illustrates the enclosure with the primary image being generated in a non-linear non flat contoured surface showing a different example of how this contouring can be arranged this is intended to show that there are numerous different versions of the same theme as shown in FIG. 6. The difference between the version shown and that of FIG. 5 is that the primary display surface curves in a different direction illustrating further the fact that the formation of a non-flat or non-linear surface can be in any plane and that different shapes will improve different content in different ways.

Another aspect of the present invention is directed to a method of providing a virtual 3D image comprising projecting a primary real image; which is preferably an animated image; onto the display surface that is irregular; transmitting the primary real image onto the partially transparent and partially reflective viewing surface (3); reflecting a visible secondary image perceivable on the opposite side of the partially transparent and partially reflective viewing surface (3) to the irregular display surface; and electronically processing components of primary image generators, either projectors or flexible LED screens, in order to create an undistorted secondary image. The secondary image created is a digital, virtual Pepper's Ghost type secondary image, which has a better quality of three-dimensional form than when projecting the primary real image onto the flat display surface. The irregular display surface is a rear projection screen or contrast filter moulded to a desired shape to achieve the desired three-dimensional effect in the reflected secondary image. The irregular display surface provides the viewer different viewing aspects of the object.

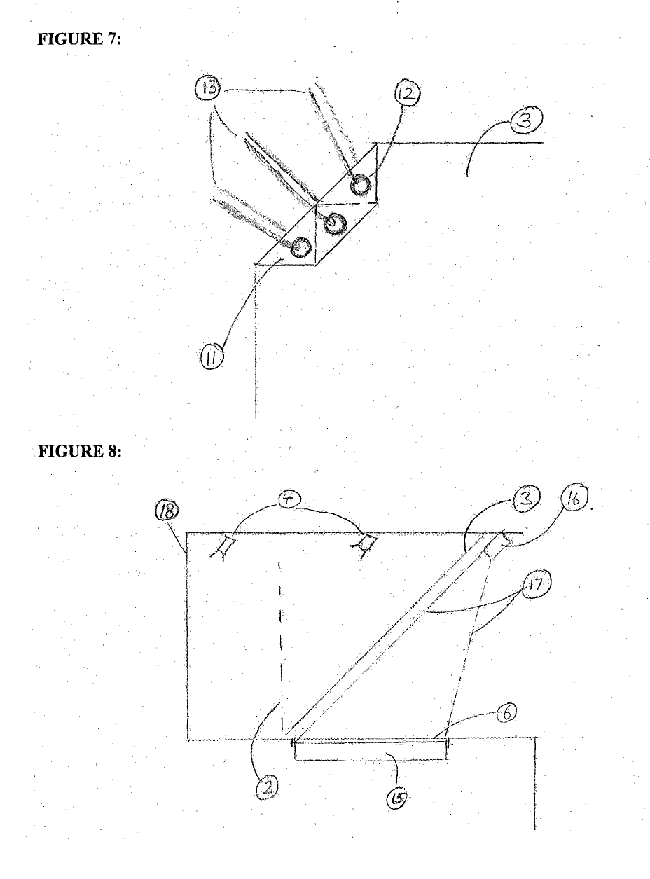

FIG. 7 illustrates corner arrangement of thermally or chemically welded or fused corners and eyelets. The partially transparent and partially reflective viewing surface (3) has to be maintained in a taught manner without creases or unevenness in order to obtain the best secondary image possible. In order to keep the partially reflective screen under the required tension, the folded corner area (11) of the reflecting foil is welded thermally or chemically to the material sheet which in turn is also thermally or chemically welded to it. The eyelets (12) pierce and are then fused or welded to the corners of the partially reflective screen. The eyelets are heat and chemically welded to the material sheet. The eyeleted partially transparent and partially reflective viewing surface (3) is then tensioned by one or more tensioning devices with the major tensioning force being applied in a diagonal pattern emanating from the central region of the partially transparent and partially reflective viewing surface (3) towards each corner region and is achieved relatively simply by the use of one or more readily available tensioning devices (13), such as nylon wire bungee cord and/or cable ties. Nylon wire, such as that used for fishing line, also helps to suspend the partially reflective screen in an apparently invisible manner. Such a tensioning arrangement results in reduced production costs and enables larger systems to be developed than was previously possible. Further eyelets (12) may be required along lateral edge regions of larger partially transparent and partially reflective viewing surface (3). The partially transparent and partially reflective viewing surface (3) is attached directly to the walls of the enclosure or to hook/metal ringlets attached to the internal surfaces of the enclosure. The above method of tensioning the partially transparent and partially reflective viewing surface (3) avoids the use of cumbersome clamping devices and/or open box sections as is known.

A method of providing secondary image with referring to FIG. 7, comprising mounting the partially transparent and partially reflective viewing surface (3) within the housing enclosure (18) and tensioning the partially transparent and partially reflective viewing surface by one or more tensioning devices (13) with a tensioning force being applied in a diagonal configuration and emanating from a centre zone of the partially reflective screen. The partially transparent and partially reflective viewing surface (3) includes at corner edge regions (11) eyelets (12) which pierce the partially transparent and partially reflective viewing surface. The diagonal tensioning force is achieved by the use of nylon fishing wire and cable ties. When the partially transparent and partially reflective viewing surface (3) is over around 2 m square, tensioning may also require additional edge force to be applied. This can be done by piercing the foil or plastic film with a leather punch or similar then by heat sealing the edges finally attaching the fishing wire directly through the hole so made and applying increasing tension with a cable tie or similar strap with a ratchet mechanism. The secondary virtual 3D image appears in a plane transverse to a viewing axis of the display apparatus, and transverse to the display surface/projection screen upon which the primary real image is displayed. The method helps to avoid the use of clamps or open box sections to tension the reflective screen/surface and production costs are reduced which enables larger systems to be developed.

FIG. 8: illustrates an arrangement, with the lower resolution LED display (15) positioned on the floor of the enclosure (18), and high resolution projector (16) to improve the performance of the virtual 3D image that is generated by lower resolution LEDs. The reflecting screen/surface leans towards the front and the bottom set back from a vertical position under the top. The primary display surface is hidden from view of the audience by virtue of its position on the floor of a raised stage. There are other functional equivalents such as; arrangements with the partially transparent and partially reflective viewing surface, the primary display and the virtual image plane; in which these elements are re-orientated such that the side elevation drawings shown becomes a plan view.

FIG. 8 also shows the arrangement of the contrast filter. Under certain circumstances this is replaced with an interference filter with similar effects in terms of contrast but improved performance in terms of the elimination of the interference pattern that can occur at the surface of the partially transparent and partially reflective viewing surface when an LED display is the primary display. The contrast or interference filters are made from any partially transparent material that can suspend light diffusing particles within or upon its surface. Typically, but not exclusively, these filters are between 50 micron and 15 mm thick. Solid or film as well as perforated compositions are possible.

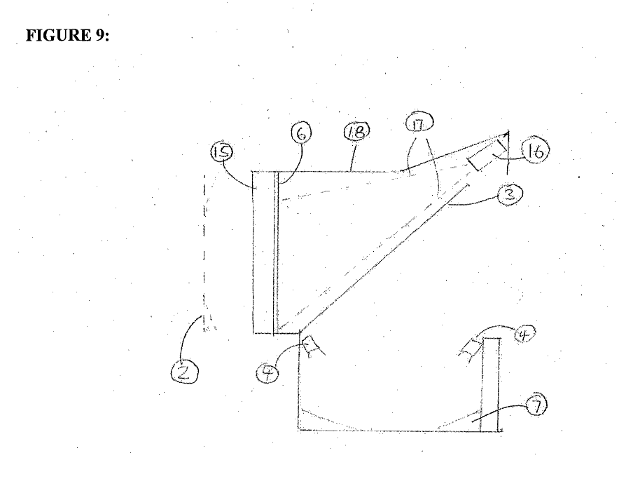

FIG. 9: illustrates an arrangement, with the lower resolution LED display (1) positioned vertically under the top/ceiling of the enclosure (18), and a high resolution projector (1.6) to improve the performance of the virtual 3D image that is generated by lower resolution LEDs. The fixed background set-works (7) are positioned on the floor of the enclosure and the contrast filter (6) is positioned close to the surface of the LED. The fixed background set-works (7) orientated in the floor when lit with very strong lights creates the impression of a vertical background at the reflected virtual image plane (2). The position of the reflected virtual 3D image plane (2) will normally but not exclusively be behind the real image plane and often advantageously behind the rear wall of the housing enclosure; thereby making a small volume appear to be much deeper than it really is. There are some advantages in certain situations where the virtual image plane may be movable through to the front of the real image. The projector (10) resolves the image on the contrast filter (6) of the LED display overlaps and fills in image detail.

1. A compact display apparatus for providing virtual 3D images comprising:
an enclosure;
a LED illumination based electronic display device;
a partially transparent and partially reflective viewing surface; and
an interference filter screen,
wherein the enclosure houses the LED illumination based electronic display device, the interference filter screen and the partially transparent and partially reflective viewing surface,
wherein the interference filter screen is positioned close to the surface of the LED illumination based electronic display device,
wherein the LED illumination based electronic display device projects a primary real image through elite the interference filter screen,
wherein the primary real image projected through the interference filter screen is optically transmitted onto the partially transparent and partially reflective viewing surface,
wherein the partially transparent and partially reflective viewing surface reflects a secondary virtual 3D image perceivable on the opposite side of the partially transparent and partially reflective viewing surface to the LED illumination based electronic display device,
wherein the reflected secondary virtual 3D image is without interference pattern, and
wherein removal of the interference pattern on the partially transparent and partially reflective viewing surface is achieved by the interference filter screen.

2-3. (canceled)

4. The display apparatus according to claim 1, wherein the primary real image is an animated virtual 3D image.

5-7. (canceled)

8. The display apparatus according to claim 1, wherein lights are added to improve the illusion, by illuminating any of the following:—enclosure walls, enclosure structure, set-works, people or objects on view; or reflected so as to be on view.

9-12. (canceled)

13. The display apparatus according to claim 1, is arranged with a stage area where upon the virtual 3D image appears as if floating in mid space.

14-16. (canceled)

17. The display apparatus according to claim 1, wherein the interference filtering is performed at the real image surface.

18. The display apparatus according to claim 8, wherein a system comprising the display apparatus, said system further comprises of high definition video camera, teleconferencing and telecasting equipment provided at a separate location for producing an animated production of 3D illusion in a second remote location, the said apparatus being based on lossless discrete wavelet transform—DWT, CODEC technology.

19. The display apparatus according to claim 18, further comprises of a lighting system to generate faux shadows of the virtual 3D image, if there were a real person or object on the stage then the lighting around would cast shadows on to the stage area.

20-21. (canceled)

22. The display apparatus according to claim 19, wherein pluralities of displays without some or all of the side or rear enclosure walls or sides; are integrated together to allow the viewer a clear line of sight through the display apparatus to the other side, the virtual images thereby appearing to float in the middle of a volume defined by the edges of the plurality of displays.

23. A compact display apparatus for providing virtual 3D images comprising:
an enclosure;
a LED illumination based electronic display device; and
a partially transparent and partially reflective viewing surface,
wherein the enclosure houses the LED illumination based electronic display device, and the partially transparent and partially reflective viewing surface,
wherein the LED illumination based electronic display device projects a primary real image,
wherein the primary real image is optically transmitted onto the partially transparent and partially reflective viewing surface,
wherein the partially transparent and partially reflective viewing surface reflects a secondary virtual 3D image perceivable on the opposite side of the partially transparent and partially reflective viewing surface to the LED illumination based electronic display device,
wherein the reflected secondary virtual 3D image is without interference pattern, and
wherein removal of the interference pattern on the partially transparent and partially reflective viewing surface is achieved by interference filter or filters positioned at a location close, very close or next to the LED displays light elements.

24. The display apparatus according to claim 23, wherein the primary real image is an animated virtual 3D image.

25-26. (canceled)

27. The display apparatus according to claim 23, wherein lights are added to improve the illusion, by illuminating any of the following: enclosure walls, enclosure structure, set-works, people or objects on view; or reflected so as to be on view.

28-31. (canceled)

32. The display apparatus according to claim 23 is arranged with a stage area where upon the virtual 3D image appears as if floating in mid space.

33. The display apparatus according to claim 27, wherein a system comprising the display apparatus, said system further comprises of high definition video camera, teleconferencing and telecasting equipment provided at a separate location for producing an animated production of 3D illusion in a second remote location, the said apparatus being based on lossless discrete wavelet transform—DWT, CODEC technology.

34-36. (canceled)

37. The display apparatus according to claim 23, wherein pluralities of the displays without some or all of the side or rear enclosure walls or side; are integrated together to allow the viewer a clear line of sight through the display apparatus to the other side, the virtual images thereby appearing to float in the middle of a volume defined by the edges of the plurality of displays.

38. (canceled)

39. A method for producing an animated production of 3D illusion in a second remote location comprising:
transmitting or broadcasting an image of a lit person or object which is filmed against a selected background in a separate location; and
generating by use of rapid image processing techniques to generate an alpha channel image combined with online hosting of the virtual 3D image of the person or object in the separate location(s) thereby broadcasting an image for the immediate playback at the second location.

40-45. (canceled)

46. The method according to claim 39 further comprises of a lighting system to generate faux shadows of the virtual 3D image, if there were a real person or object on the stage then the lighting around would cast shadows on to the stage area.
